(19) United States
(12) Patent Application Publication
(10) Pub. No.: US 2006/0253210 A1
(43) Pub. Date: Nov. 9, 2006

(54) Intelligent Pace-Setting Portable Media Player

(75) Inventor: Louis B Rosenberg, Pismo Beach, CA (US)

Correspondence Address: LAW OFFICE OF PHILIP A STEINER, 846 HIGUERA STREET, SUITE 4, SAN LUIS OBISPO, CA, 93401, US

(73) Assignee: Outland Research, LLC, Pismo Beach, CA (US)

(21) Appl. No.: 11/461,375

(22) Filed: Jul. 31, 2006

Related U.S. Application Data
(63) Continuation-in-part of application No. 11/427,320, filed on Jun. 28, 2006.
Application No. 11/427,320 is a continuation of application No. 11/367,178, filed on Mar. 2, 2006.
(60) Provisional application No. 60/765,856, filed on Feb. 7, 2006.
(60) Provisional application No. 60/665,291, filed on Mar. 26, 2005.

(51) Int. Cl. G06F 17/00

(52) U.S. Cl. 700/94

(57) ABSTRACT

A system, method and computer program product for intelligently selecting and playing a musical media file on a portable media player in accordance with a preestablished exercise regimen. The intelligent selection is programmatically performed as a means of establishing a desired pace for a user to maintain in accordance with the preestablished exercise regimen. The program determines an approximate footfall rate for the user to perform so as to achieve the desired pace value included in the preestablished exercise regimen, selects a musical media file from a plurality of musical media files stored in a secondary memory whose musical beat rate more closely corresponds to the determined approximate footfall rate than other of the plurality of musical media files stored in a secondary memory and plays at least a portion of the retrieved musical media file to the user as the user performs a corresponding portion of the preestablished exercise regimen. In some embodiments the musical media file may be tempo-adjusted when played to achieve better matching between the audible musical beat and the pace-setting requirements of the particular exercise regimen.

### CROSS-REFERENCE TO RELATED APPLICATIONS

This application is a continuation-in-part of co-pending non-provisional U.S. patent application Ser. No. 11/427,320 filed Jun. 26, 2006 and Ser. No. 11/367,178 filed Mar. 2, 2006; U.S. patent application Ser. No. 11/427,320 is a continuation of U.S. patent application Ser. Nos. 11/267,079 filed Nov. 3, 2005 and 11/285,534 filed Nov. 22, 2005; this application also claims benefit and priority; under 35 U.S.C. § 119(e) U.S. from provisional patent application Ser. No. 60/817,553 filed Jun. 28, 2006, entitled “Intelligent Pace-Setting Portable Media Player,” to the instant inventor;

U.S. patent application Ser. No. 11/367,178 claims benefit and priority under 35 U.S.C. § 119(e) U.S. from provisional patent application Ser. No. 60/683,020 filed May 19, 2005;

U.S. patent application Ser. No. 11/427,320 claims benefit and priority under 35 U.S.C. § 119(e) U.S. from provisional patent application Ser. No. 60/765,856 filed Feb. 7, 2006;

U.S. patent application Ser. No. 11/267,079 claims benefit and priority under 35 U.S.C. § 119(e) to U.S. provisional patent application Ser. Nos. 60/665,291 filed Mar. 26, 2005 and 60/648,197 filed Jan. 27, 2005;

U.S. patent application Ser. No. 11/285,534 claims benefit and priority under 35 U.S.C. § 119(e) to U.S. provisional patent application Ser. Nos. 60/665,291 filed Mar. 26, 2005, 60/651,771 filed Feb. 9, 2005 and 60/648,197 filed Jan. 27, 2005;

U.S. patent application Ser. Nos. 11/223,386 filed Sep. 9, 2005; Ser. No. 11/298,434 filed Dec. 9, 2005; Ser. No. 11/354,667 filed Feb. 14, 2006; and Ser. No. 11/367,178 filed Mar. 2, 2006 are related patent applications;

all of the patent applications identified above are to the instant inventor and a common assignee and are hereby incorporated by reference in their entirety as if fully set forth herein.

### BACKGROUND

Portable media players have become popular personal entertainment devices due to their highly portable nature, their ability to provide accessibility to a large library of stored musical media files, and interconnectivity with existing computer networks, for example the Internet. The accessibility and simplicity in downloading music and other electronic media continues to fuel the popularity of these devices as is exemplified by Apple Computer, Inc.'s highly successful iPod™ portable media player. Other manufacturers have competing Media Players offering various functionalities and file playing compatibilities in an effort to differentiate their products in the marketplace.

As discussed in Apple Computer, Inc., patent application, US 2004/0224638 A1, Ser. No. 10/423,490 to Fadell, et al., filed on Apr. 25, 2003, which is herein incorporated by reference in its entirety; an increasing number of consumer products are incorporating circuitry to play musical media files and other electronic media. For example, many portable electronic devices such as cellular telephones and personal digital assistants (PDAs) include the ability to play electronic musical media in many of the most commonly available file formats including MP3, AVI, WAV, MPG, QT, WMA, AIFF, AU, RAM, RA, MOV, MIDI, etc. With a wide variety of devices and file formats emerging, it is expected that in the near future a large segment of the population will have upon their person an electronic device with the ability access music files from a library of musical media files in local memory and/or over a computer network, and play those music files at will. Currently, there exists a need to coordinate the intelligent selection and play of musical media files with the repetitive gait movements of the user. Such synchronization will enhance the user's listening experience.

### SUMMARY

This disclosure addresses the deficiencies of the relevant art and provides exemplary systematic, methodic and computer program product embodiments which provides a motion responsive portable media player that enables a musical media file to be automatically selected from a plurality of musical media files based at least in part upon a computational matching of one or more rate parameters that represent a user's desired and/or actual repetitive physical gait motion, and one or more parameters representing a tempo, beat and/or rhythm of the matching musical media file. More specifically, the various embodiments are operative to select musical media files for play and/or modify the playback speed of musical media files currently being played such that a user who walks, jogs, or runs with a gait pacing that approximately matches the beats of the playing musical piece will achieve a desired pacing designated by a preestablished exercise regimen.

In an exemplary systematic embodiment, a system for intelligently selecting and playing musical media files on a portable media player in accordance with a preestablished exercise regimen is provided. This general exemplary systematic embodiment comprises; a processor associated with the portable media player; a main memory functionally coupled to the processor; a secondary memory functionally coupled to the processor; the secondary memory having retrievably stored therein; the preestablished exercise regimen including; a desired pace value to which a user desires to maintain for a discrete interval, the desired pace value having a determinable relationship to an approximate footfall rate of the user; a plurality of musical media files, each of which including a musical beat rate associated therewith.

A program is provided which is operatively loadable into the main memory having instructions executable by the processor to; retrieve the preestablished exercise regimen from the secondary memory; determine the approximate footfall rate of the user in dependence on at least the desired pace value; select a musical media file from the plurality of musical media files in the secondary memory based at least in part upon the selected musical media file having a musical beat rate which more closely corresponds to the approximate footfall rate than other of the plurality of musical media files; retrieve the musical media file from the secondary memory whose musical beat rate more closely corresponds with that of the approximate footfall rate; and play at least a portion of the retrieved musical media file to the user during the user's performance of at least a portion of the discrete interval of the preestablished exercise regimen to which the desired pace value corresponds.

In a first related exemplary systematic embodiment, the preestablished exercise regimen is divisible into a plurality of discrete intervals, each of which having a desired pace value associated therewith.

In a second related exemplary systematic embodiment, the discrete interval is one of, a time interval, a distance interval, a number of footfalls, and any combination thereof.

In a third related exemplary systematic embodiment, the desired pace value is one of, a footfall rate, a time to achieve a specific distance, a speed and any combination thereof.

In a fourth related exemplary systematic embodiment, each of the plurality of musical media files is further associated with one or more weighting values; the one or more weighting values being indicative of a selection preference of the user.

In a fifth related exemplary systematic embodiment, the program further includes instructions executable by the processor to select the musical media file in further dependence upon the one or more weighting values.

In a sixth related exemplary systematic embodiment, the approximate footfall rate of the user is dependent at least in part upon a stride length of the user.

In a seventh related exemplary systematic embodiment, the stride length is entered by the user.

In an eighth related exemplary systematic embodiment, one or more motion sensors are further provided; each of the motion sensors being operative to transmit motion signals to the processor indicative of one of; a current location, a distance traveled, a speed traveled, and any combination thereof, which is induced by dynamic movements of the user.

In a ninth related exemplary systematic embodiment, the program further includes instructions executable by the processor to dynamically determine an actual stride length of the user from the received motion signals.

In a tenth related exemplary systematic embodiment, a gait sensor is further provided; the gait sensor being operative to transmit gait signals to the processor indicative of an actual footfall rate, an actual footfall count, and any combination thereof, which is induced by dynamic movements of the user.

In an eleventh related exemplary systematic embodiment, the program further includes instructions executable by the processor to dynamically determine an actual stride length of the user based at least in part on the received gait signals.

In a twelfth related exemplary systematic embodiment, the program determines the actual stride length of the user by dividing a determined distance traveled of the user by the actual footfall count of the user.

In a thirteenth related exemplary systematic embodiment, the program determines the actual stride length of the user by dividing an actual speed of the user by the actual footfall rate of the user.

In a fourteenth related exemplary systematic embodiment, one of the plurality of discrete intervals includes a current discrete interval, the current discrete interval having associated therewith, the desired pace value to be used in selecting a musical media file for current play to the user.

In a fifteenth related exemplary systematic embodiment, the program further includes instructions executable by the processor to set a next discrete interval of the preestablished exercise regimen as the current discrete interval is completed by the user.

In a sixteenth related exemplary systematic embodiment, the user's completion of the previous current discrete interval is determined based at least in part upon one or more sensor signals indicative of the user's location, distance of travel, speed of travel, footfall count, footfall rate, elapsed time, and any combination thereof.

In a seventeenth related exemplary systematic embodiment, the program further includes instructions executable by the processor to select a next musical media file for play to the user in dependence on one of; a completion of play of a current musical media file, a completion of the current discrete interval, and any combination thereof.

In an eighteenth related exemplary systematic embodiment, an inclination sensor is provided and is functionally coupled to the processor; the inclination sensor being operable to transmit signals to the processor indicative of a non-level terrain inclination currently being traversed by the user.

In a nineteenth related exemplary systematic embodiment, the program further includes instructions executable by the processor to apply a tempo adjustment factor to the musical media file, the tempo adjustment factor being based at least in part on the inclination sensor signals and applied to retrieved musical media file during play, so as to compensate for deviations in the desired pace value resulting from the user's traversal of the non-level terrain inclination.

In a twentieth related exemplary systematic embodiment, the tempo adjustment factor varies a play back rate of the retrieved musical media file during play such that if the user approximately matches his or her footfall rate to a tempo-adjusted musical beat, the user will generally achieve the desired pace value.

In a twenty-first related exemplary systematic embodiment, the program further includes instructions executable by the processor to apply an audible pitch adjustment factor to normalize an audible pitch of the retrieved musical media file during play, in which the tempo adjustment factor has been applied.

In a twenty-second related exemplary systematic embodiment, the program further includes instructions executable by the processor to apply a tempo adjustment factor to the retrieved musical media file during play, the tempo adjustment factor varying a tempo of the retrieved musical media file during play such that the musical beat rate more closely corresponds to the approximate footfall rate.

In a twenty-third related exemplary systematic embodiment, the program further includes instructions executable by the processor to determine if the actual stride length of the user has varied during the play of the retrieved musical file; the program compensating for the variations in the actual stride length by varying a tempo of the musical media file during play such that the musical beat rate provides an opportunity for the user to achieve compliance with the desired pace value.

In a first exemplary methodic embodiment, a method for intelligently selecting and playing musical media files on a portable media player in accordance with a preestablished exercise regimen is provided. This exemplary methodic embodiment comprising; providing instructions executable by a processor associated with the portable media player for programmatically; retrieving the preestablished exercise regimen from a secondary memory functionally coupled to the processor; determining an approximate footfall rate for a user in dependence on at least a desired pace value included in the retrieved preestablished exercise regimen; selecting a musical media file from the plurality of musical media files stored in the secondary memory based at least in part on the selected musical media file having a musical beat rate which more closely corresponds to the approximate footfall rate than other of the plurality of musical media files; retrieving the selected musical media file from the secondary memory; and playing at least a portion of the retrieved musical media file to the user during the user's performance of least a portion of the preestablished exercise regimen to which the desired pace value corresponds.

In a first related exemplary methodic embodiment, each of the plurality of musical media files is further associated with one or more weighting values; each of the weighting values being indicative of a selection preference of the user.

In a second related exemplary methodic embodiment, the embodiment further including selecting a musical media file from the plurality of musical media files in further dependence upon the one or more weighting values.

In a third related exemplary methodic embodiment, the approximate footfall rate is dependent at least in part upon a stride length of the user.

In a fourth related exemplary methodic embodiment, the stride length is entered by the user.

In a fifth related exemplary methodic embodiment, the embodiment further providing one or more motion sensors, each of the motion sensors being operative to transmit motion signals to the processor indicative of one of, an elapsed time, a current location, a distance traveled, an inclination, a speed, and any combination thereof, accomplished by the user.

In a sixth related exemplary methodic embodiment, the embodiment further including dynamically determining an actual stride length from the one or more received motion signals.

In a seventh related exemplary methodic embodiment, the embodiment further including dynamically determining the actual stride length of the user from the one or more received motion signals in dependence with one of; an actual footfall rate and an actual footfall count.

In an eighth related exemplary methodic embodiment, further including determining the actual stride length of the user by dividing the distance traveled by the user by the actual footfall count of the user imparted over the distance traveled.

In a ninth related exemplary methodic embodiment, the preestablished exercise regimen is divisible into a plurality of discrete intervals, each of the plurality of discrete intervals having a desired pace value associated therewith.

In a tenth related exemplary methodic embodiment, the embodiment further including selecting another discrete interval based upon the user's completion of a current discrete interval.

In an eleventh related exemplary methodic embodiment, the embodiment further including selecting another musical media file for play to the user in dependence on one of, a completion of play of a current musical media file, a completion of a current discrete interval of the preestablished exercise regimen, and any combination thereof.

In a twelfth related exemplary methodic embodiment, the embodiment further including applying a tempo adjustment factor to the retrieved musical media file during play; the tempo adjustment factor varying a tempo of the retrieved musical media file during play such that the musical beat rate more closely corresponds to the approximate footfall rate.

In a thirteenth related exemplary methodic embodiment, the embodiment further including determining if the actual stride length of the user has varied during the playing of the musical media file; and compensating for the variations in the actual stride length by varying a tempo of the playing musical media file such that the musical beat rate provides an opportunity for the user to achieve compliance with the desired pace value.

In a first exemplary computer program product embodiment, a computer program product embodied in a tangible form comprising instructions executable by a processor associated with a portable media player to intelligently select and play musical media files is provided. In this exemplary computer program product embodiment, the executable instructions comprise; retrieving a preestablished exercise regimen from a secondary memory functionally coupled to the processor; determining an approximate footfall rate for a user in dependence on at least a desired pace value included in the retrieved preestablished exercise regimen; selecting a musical media file from a plurality of musical media files in the secondary memory based at least in part upon the selected musical media file having a musical beat rate which more closely corresponds to the approximate footfall rate than other of the plurality of musical media files; retrieving the selected musical media file from the secondary memory; and playing at least a portion of the retrieved musical media file to the user during the user's performance of at least a portion of the preestablished exercise regimen to which the desired pace value corresponds.

In a first related exemplary computer program product embodiment, the preestablished exercise regimen is divisible into a plurality of discrete intervals, each of the discrete intervals having a desired pace value associated therewith.

In a second related exemplary computer program product embodiment; each discrete interval is one of, a time interval, a distance interval, a number of footfalls, and any combination thereof.

In a third related exemplary computer program product embodiment, the desired pace value is one of, a footfall rate, a time to achieve a specific distance, a speed and any combination thereof.

In a fourth related exemplary computer program product embodiment, each of the plurality of musical media files is further associated with one or more weighting values; each of the one or more weighting values being indicative of a selection preference of the user.

In a fifth related exemplary computer program product embodiment, the instructions executable by the processor further includes; selecting the musical media file in further dependence upon the one or more weighting values.

In a sixth related exemplary computer program product embodiment, the approximate footfall rate of the user is dependent at least in part upon an approximate stride length of the user.

In a seventh related exemplary computer program product embodiment, further including instructions executable by the processor to dynamically determine an actual stride length of the user from one or more received sensor signals; the received sensor signals being indicative of one of; an actual distance traveled, a speed, an actual footfall rate, an actual footfall count and any combination thereof, accomplished by the user.

In an eighth related exemplary computer program product embodiment, the tangible form is one of, a logical media, a magnetic media and an optical media.

In various other exemplary embodiments, the portable media player is operative to generate and/or store a preestablished exercise regimen which includes one or more pacing setting parameters. The Pace setting parameters are variable that indicate a desired rate of walking, jogging, or running of the user. The pacing value may be stored in various forms including but not limited to a desired number of footfalls per minute (FPM), a desired speed, or a desired mile time (e.g., six minute mile).

Thus by storing one or more preplanned pacing value in memory, the portable media player may maintain a target pace for the user as part of a planned exercise regimen. In many embodiments the preestablished exercise regimen is a set of target paces that vary over the duration of the walking, jogging, or running activity. For example the planned exercise regimen may be a set of paces along with a time duration (or a distance interval) that the pace is to be maintained. Each portion of the full exercise is generally referred to as an interval. When a user exercises (i.e. runs, walks, or jogs) such that his or her pacing is deliberately varied between intervals, it is often referred to as interval training.

The music selection program may thus be configured to select musical media files for the user over the duration of the preestablished exercise regimen that have a primary audible musical beat rate that matches the desired footfall rate of the user to achieve the target pace stored in the preestablished exercise regimen. Thus as a user runs a stored exercise regimen, the portable media player may be configured to automatically select musical pieces for play during each interval of the regimen such that if the user runs at a pace such that his footfalls match the primary beats of the music, he or she will achieve the desired pace.

In this way the portable media player automatically may select musical media files from the plurality of musical media files stored in memory and play them to the user during each defined interval of a preestablished exercise regimen such that the beat of the musical media files will guide the user to achieve the desired pace of that interval of the preestablished exercise regimen. The desired musical media file may be selected using a weighted random selection process such that it is selected at random from a plurality of musical media files such that musical media files which more closely match the desired musical beat rate are more likely to be selected. In some such weighted random selection processes, only musical media files that are within certain proximity of the musical beat rate are considered for selection by the weighted random selection routine.

For musical media files that are selected such that the musical beat rate does not exactly correspond to the desired footfall rate of the user, the program of portable media player may be configured to increase or decrease the playback speed or tempo of the musical media file such that the desired musical beat rate is achieved. The portable media player may also be operative to perform a pitch adjustment feature such that the slight pitch change that results from varying the playback speed of the musical media file is compensated for.

The portable media player may also select musical media files from a plurality of musical media files available for play and play them such that the audible musical beat rate that more closely corresponds to the desired footfall rate of the user as prescribed by the stored exercise regimen. This serves as a highly motivational feature, guiding the user through his or her exercise regimen by automatically playing musical media files from the plurality of available musical media files to which the user walks, jogs, or runs, matching his or her footfalls to beats in the music being played.

### BRIEF DESCRIPTION OF THE DRAWINGS

The features and advantages will become apparent from the following detailed description when considered in conjunction with the accompanying drawings. Where possible, the same reference numerals and characters are used to denote like features, elements, components or portions. Optional components or feature may be shown in dashed or dotted lines and noted as optional in this specification. It is intended that changes and modifications can be made to the described exemplary embodiments without departing from the true scope and spirit of the subject inventive embodiments.

FIG. 1—depicts a generalized and exemplary block diagram of a portable media player described in the various exemplary embodiments.

FIG. 2—depicts an exemplary detailed block diagram of a program which is configured to determine a musical media file to retrieve in dependence on one or more correlations made between parameters contained in a preestablished exercise regimen and those associated with a musical media file.

FIG. 3—depicts an exemplary detailed block diagram of a user providing repetitive movements which are sensed and used by a portable media player to select and/or play a musical media file which approximately matches one or more correlation parameters.

FIG. 3A—depicts an exemplary detailed block diagram of a portable media player configurable with an internal and/or external sensor(s).

FIG. 4—depicts an exemplary flow chart of a process for intelligently selecting and playing musical media files which approximately matches one or more correlation parameters.

### DETAILED DESCRIPTION

A user movement responsive portable media player is provided which is operative to automatically select and play one or more musical media files to a user from a plurality of musical media files such that each selected musical media file when played has an audible beat that is approximately correlated to the actual footfall rate that the user would need to perform to achieve a desired pace of an exercise activity then being performed by the user. Such a portable media player is useful for a user performing footfall related exercise activities, for example, walking, jogging, hopping, skipping and/or running activities in which the user has one or more desired pacing goals to achieve during at least a portion of the activity. The portable media player system disclosed herein, allows the user to select and/or create one or more exercise regimens where the musical media files are automatically selected and played by the portable media player to assist the user in obtaining the desired goal.

As is described herein, a preestablished exercise regimen is a store of data that includes one or more values from which one or more desired exercise pacing rates may be derived. In an embodiment, a preestablished exercise regimen is a set of pacing values, each pacing value representing a desired pacing rate for an interval of an exercise routine. As described herein an interval of an exercise regimen is a portion of an exercise regimen defined in terms of a distance covered, an elapsed time, a footfall count, a number of played musical media files, or a combination thereof. As also described herein a stride length value is a value for a user during at least a portion of an exercise regimen that represents or approximates the spatial distance covered by the user between sequential footfalls. As is further described herein, a current stride length value for a user may be used in combination with a desired pace value to derive a desired footfall rate for the user during an exercise regimen. As also will be described herein stride length may be used in combination with detected actual footfalls of a user to monitor a user's progress through a currently performed exercise regimen.

Where necessary, computer programs, algorithms and routines are envisioned to be programmed in a high level language object oriented language, for example Java™ C++, C#, or Visual Basic™.

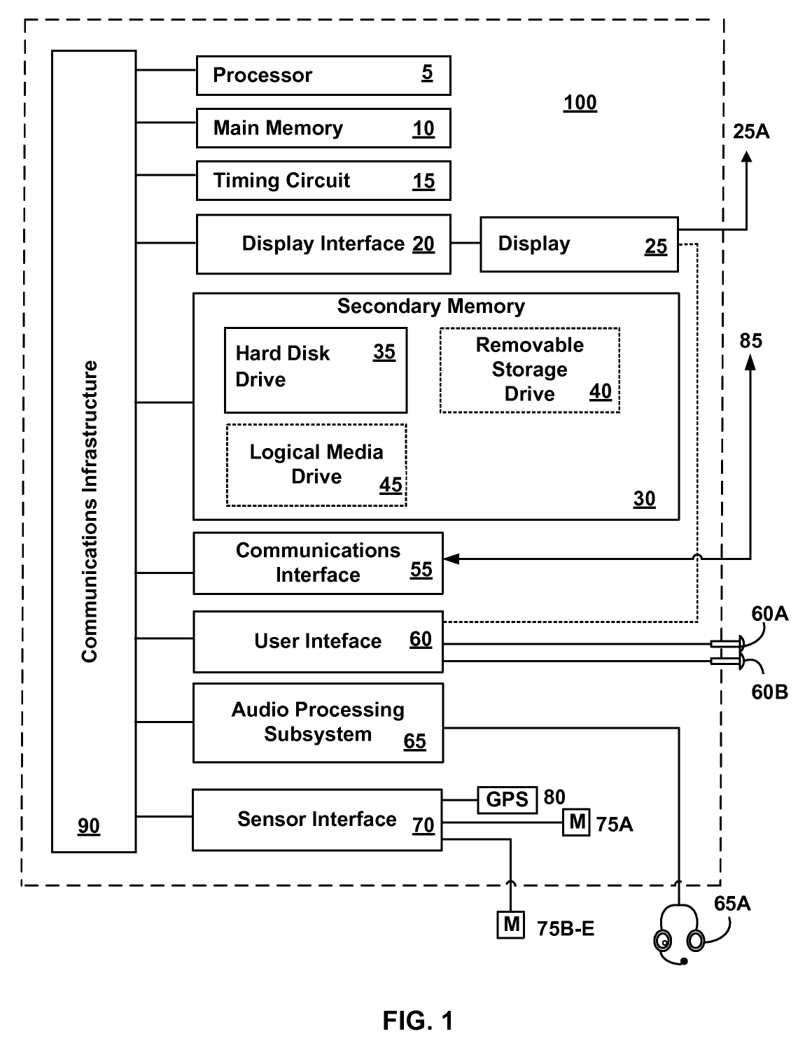

FIG. 1 provides a generalized and exemplary block diagram of a portable media player 100 as is described in the various exemplary embodiments. The portable media player 100 includes a communications infrastructure 90 used to transfer data, memory addresses where data items are to be found and control signals among the various components and subsystems associated with or coupled to the portable media player 100. A processor 5 is provided to interpret and execute logical instructions stored in the main memory 10.

The main memory 10 is the primary general purpose storage area for instructions and data to be processed by the processor 5. The main memory 10 is used in its broadest sense and includes RAM, EEPROM and ROM. A timing circuit 15 is provided to coordinate activities within the portable media player 100 in near real time and may be used to make time-based assessments of sensor data collected by one or more internal sensors 75A, 80 and/or coupled to a sensor interface 70 which may optionally receive sensor data from one or more external sensors 75B-E.

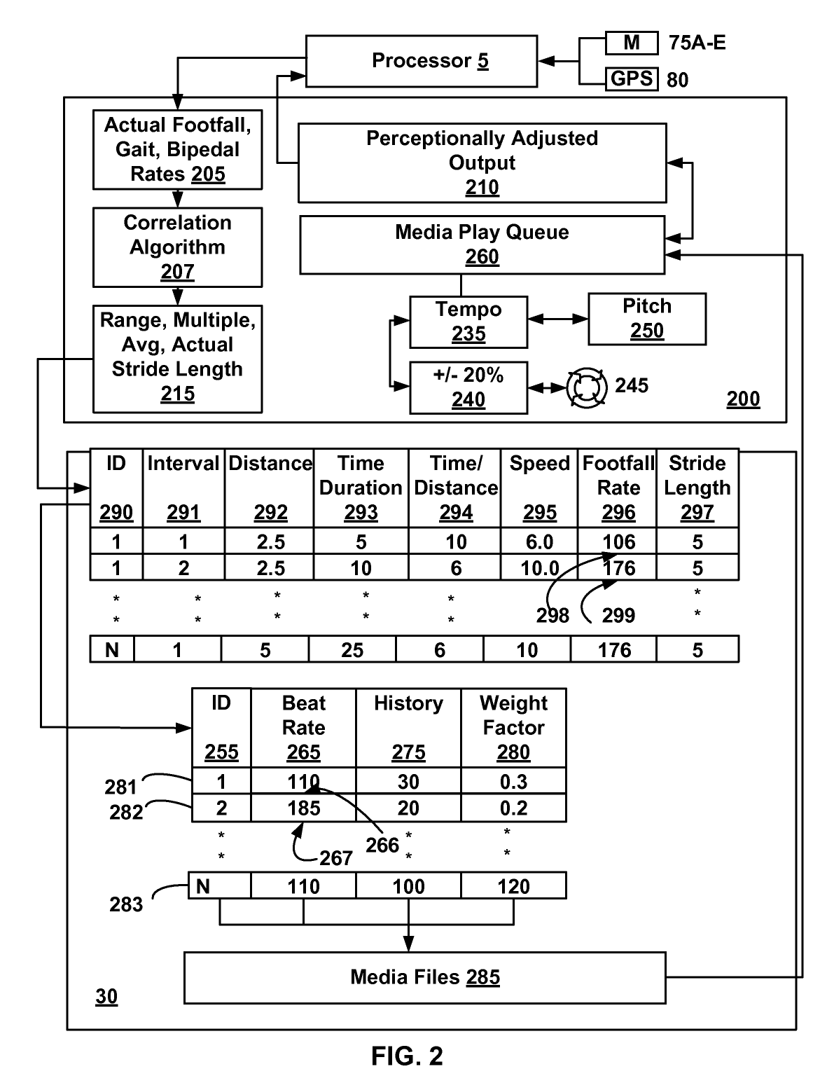

In certain exemplary embodiments, at least a portion of the sensors 75A-E may be configured to detect a user's repetitive physical activity for example, running, walking and jogging. The timing circuit 15 may also be used in conjunction with a program 200 (FIG. 2) to evaluate a tempo, beat and/or rhythm of musical media files stored, accessed by, and/or played by the portable media player 100. The processor 5, main memory 10 and timing circuit 15 are directly coupled to the communications infrastructure 90.

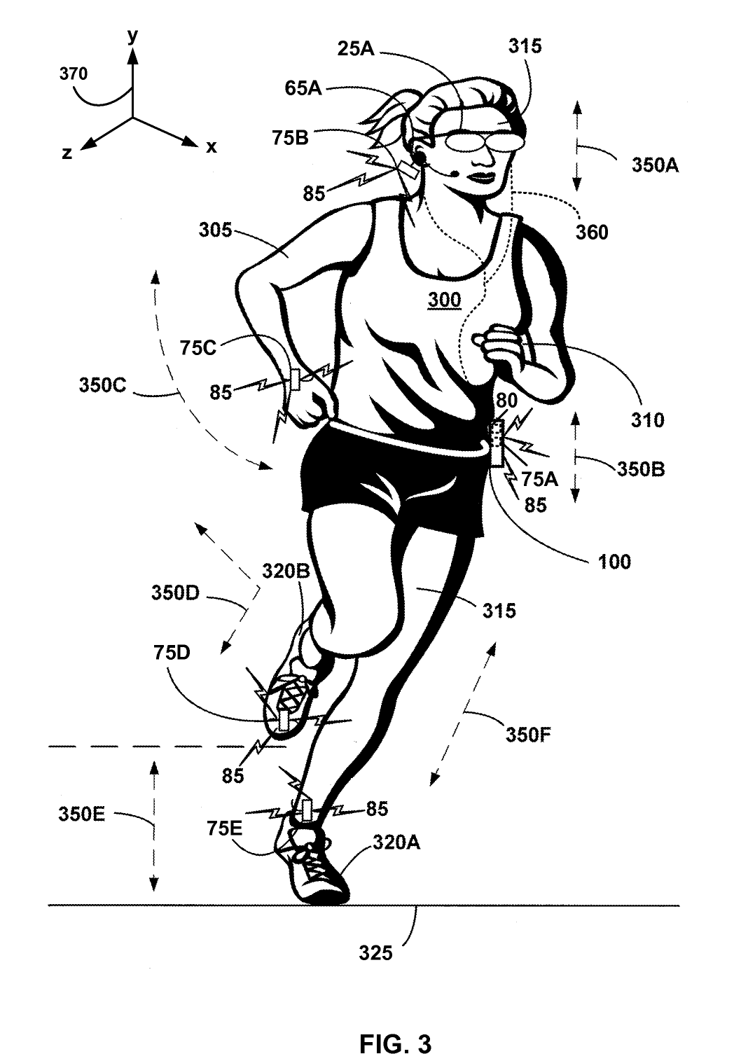

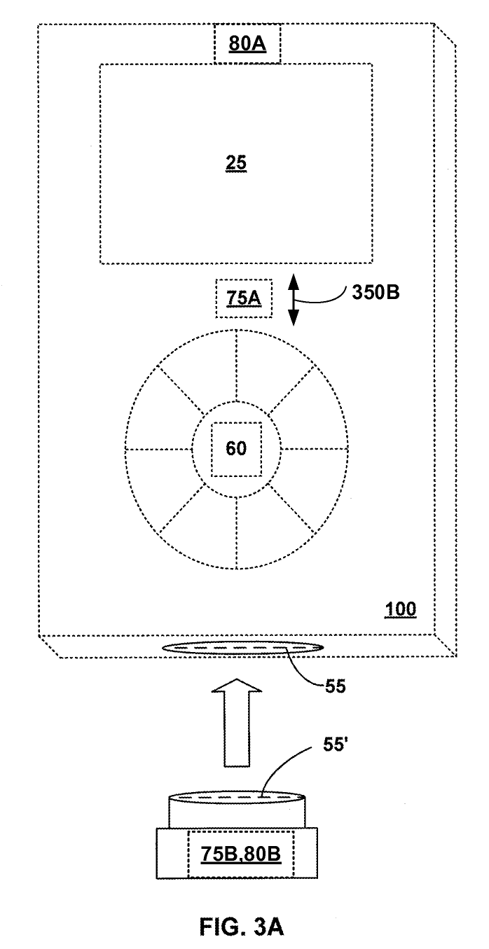

A display interface 20 is provided to drive one or more displays 25, 25A associated with the portable media player 100. The display interface 20 is electrically coupled to the communications infrastructure 90 and provides signals to the display(s) 25, 25A for visually outputting both graphics and alphanumeric characters. In an exemplary embodiment, a display 25 may be incorporated into the housing of the portable media player 100 and/or may be another separate device worn by the user 25A (FIG. 3).

The display 25 may also be coupled to a user interface 60, 60A, B for interacting with software or firmware being executed by the processor 5. The display interface 20 may include a dedicated graphics processor and memory to support the displaying of graphics intensive media. The internal display 25 may be of any type (e.g., cathode ray tube, gas plasma) but in most circumstances will usually be a solid state device such as liquid crystal display. The external display 25A necessitates a lightweight construction, generally an LCD screen.

A secondary memory subsystem 30 is provided which houses retrievable data storage units such as a hard disk drive 35, an optional removable storage drive 40, and/or an optional logical media storage drive 45. One skilled in the art will appreciate that the hard drive 35 may be replaced with flash memory. The secondary memory 30 may be used to store a plurality of musical media files, including but not limited to a plurality of digital musical media files, a plurality of digital images, a plurality of personal photographs, a plurality of video files, and/or a plurality of other media items.

The optional removable storage drive 40 may be a replaceable hard drive, optical media storage drive or a solid state flash RAM device. Both the optional removable storage drive 40 and optional logical media storage drive 40 may include a flash RAM device, an EEPROM encoded with playable media, or optical storage media (CD, DVD). The optional removal storage drive 40 may be connected directly to the communications infrastructure 90 or in alternate exemplary embodiments, via a communications interface 55.

The communications interface 55 subsystem is provided which allows for electrical connection of peripheral devices to the communications infrastructure 90 including, serial, parallel, USB, Firewire™ connectivity and proprietary communications connections usually associated with a docking cradle (not shown.)

The communications interface 55 also facilitates the remote exchange of data and synchronizing signals between the portable media player 100 and other devices in processing communications 85 with the portable media player 100. The other devices may include one or more external sensors 75B-E that are disposed elsewhere upon the user's body. The other devices may also include a wireless headset 65A, a remote display 25A, another portable media player and/or a remote server.

The communications interface 55 is envisioned to include a radio frequency transceiver normally associated with wireless computer networks for example, wireless computer networks based on BlueTooth™ or the various IEEE standards 802.11x, where x denotes the various present and evolving wireless computing standards, for example WiMax 802.16 and WRANG 802.22. Alternately, digital cellular communications formats compatible with for example GSM, 3G and evolving cellular communications standards. Both peer-to-peer (PPP) and client-server models are envisioned for implementation in various inventive embodiments. In a third alternative exemplary embodiment, the communications interface 55 may also include hybrids of computer communications standards, cellular standards and evolving satellite radio standards.

A user interface 60 is provided as the means for a user to control and interact with the portable media player 100. The user interface 60 provides interrupt signals to the processor 5 that may be used to interpret user interactions with the portable media player 100. For purposes of this specification, the term user interface 60, 60A,B includes the hardware and interface executable code by which a user interacts with the portable media player 100 and the means by which the portable media player 100 conveys information to the user. The user interface 60 may be used in conjunction with the display(s) 25, 25A in order to simplify interactions with the portable media player 100 when the user is performing physical activities. The user interface 60 employed on the portable media player 100 may include a pointing device (not shown) such as a mouse, thumbwheel or track ball, an optional touch screen (not shown); one or more push-button switches 60A, 60B; one or more sliding or circular potentiometer controls (not shown) and one or more switches (not shown.)

An audio processing subsystem 65 is provided to output analog audio to the user's headset 65A and input commands, messages and other verbal information from a microphone attached to the headset 65A. The audio processing subsystem 65A is generally known in the relevant art, for example, personal computer sound cards.

The portable media player 100 may include one or more sensors 75A-E for detecting characteristics of a user's physical repetitive movement as well as for monitoring a user's progress through a preplanned exercise regimen. For example, a gait sensor may be employed to detect footfall events, footfall counts, and/or footfall rates of the users. Such footfall data may be used alone or in combination with stride length information to monitor a user's progress through a preplanned exercise regimen. Similarly a separate optional motion sensor 80 may be incorporated for utilizing global positioning system (GPS) resources. The GPS sensor 80 may be used to determine the actual distance and/or speed traversed by the user as he or she performs a preplanned exercise regimen. The GPS sensor 80 along with the gait sensor 75A-E may be used to determine a current stride length for the user. This is may be performed, for example, by dividing a distance traveled by the user, as determined from GPS data, by a number of footfalls preformed by the user over that distance, as determined from gait sensor data. Alternately this may be performed by dividing a speed of the user, as determined from GPS data, by a footfall rate of the user, for a particular time or distance interval.

In addition, the portable media player 100 configured with the GPS receiver 80 may be used to determine if a user is traversing an incline or decline during a current portion of the preestablished exercise regimen. This is may be performed by detecting changes in elevation of the user over a short period of time. The change in elevation divided by the change in distance indicates incline or decline rate of the terrain (i.e. is the road or path going up or down a steep hill). This may alternately performed by accessing a database of inclination data that is indexed by GPS coordinates. Alternately a dedicated inclination sensor may be used, such as an inclinometer and/or accelerometer, to determine if a user is traversing an incline or a decline during a current portion of the preestablished exercise regimen.

In embodiments incorporating a GPS receiver motion sensor, accurate progress determinations may be provided for a particular exercise regimen. In addition, the GPS data received may be used to compute the actual stride length 215 of the user. In such embodiments, sensor 75A-E based footfall counts and/or rates may be used in combination with the GPS data to repeatedly compute updated values for the actual stride length of the user as the user performs a particular exercise regimen. For example an updated stride length 215 for the user may be computed every 10 seconds as the user performs a preestablished exercise regimen. In this way the routines of the various embodiments may have access to updated and accurate stride length 215 of the user as it may vary during an exercise period with user fatigue, road conditions, and/or terrain inclination.

The motion sensors 75A-E may utilize accelerometers, suitably configured momentary switches, magnetometers and/or pressure switches. The motion sensor(s) 75A-E may be an accelerometer mounted within and/or affixed to the housing of the portable media player 100. The portable media player 100 may generally be worn upon or otherwise affixed to the body of the user such that repetitive gait motions of the user induce accelerations in the portable media player 100 housing that are detectable by the accelerometer 75A-E. For example, the portable media player 100 may be worn on the belt of the user such that accelerations are upon the housing of the portable media player 100 as a result of the user's gait related footfalls. Such accelerations are generally induced with a characteristic time varying profile indicative of the repetitive gait motion of the user. Example details of such footfall assessments are provided in co-pending patent applications by the present inventor, including Ser. No. 11/427,320 entitled, “Gait Responsive Portable Media Player” filed Jun. 28, 2006 and related provisional application 60/765,856 filed Feb. 7, 2006 and 60/648,197 filed Jan. 27, 2005. Additional details of exercise related footfall assessments are provided in co-pending patent application by the present inventor, including 11/367,178 entitled “Ambulatory Based Human Computer Interface,” filed Mar. 2, 2006 and its priority provisional application 60/683,020 filed May 19, 2005.

Analogously, a sensor 75D may be an accelerometer mounted within or upon the user's shoe 320B (FIG. 3.) By detecting accelerations within or upon a user's shoe, footfall accelerations may be directly detected. Alternately, a pressure sensor or momentary switch may be mounted within or upon the user's shoe 320B for detecting the actual footfalls of the shoe when it contacts the ground 325. A variety of sensor technologies for footwear may be employed in the current embodiments for detecting one or more parameters about a user's motion; including the sensor technology disclosed in the instant inventor's co-pending U.S. patent application Ser. No. 11/298,434 filed Dec. 9, 2005; Ser. No. 11/354,667 filed Feb. 14, 2006; and Ser. No. 11/367,178 filed Mar. 2, 2006 all of which are herein incorporated by reference in their entirety as if fully set forth herein. As also disclosed in Ser. No. 11/367,178, footfall sensors may be incorporated within a surface a user is exercising upon such as a platform or mat.

When the motion sensors 75B-E are external to the portable media player 100, a wireless 85 arrangement may be provided which utilizes for example, Bluetooth™ or an equivalent wireless technology. Where required, the sensors 75A-E, 80 may be connected through a separate sensor interface 70. In such circumstances, the sensors 75A-E, 80 may be directly connected to the sensor interface 70 or indirectly utilizing the communications interface 55 and the communications infrastructure 90 to transfer information to the sensor interface 70.

Thus, when the portable media player 100 is provided with a suitable program 200 (FIG. 2), data provided by the sensors 75A-E may be used to select and play a musical media file which approximately corresponds in terms of a beat rate to the user's preestablished exercise regimen. References to the program 200 may be made in both singular and plural form. No limitation is intended by such grammatical usage as one skilled in the art will appreciate that multiple programs, objects, subprograms routines, algorithms, applets, contexts, etc. may be implemented programmatically to implement the various exemplary embodiments. In addition certain aspects of the program may be performed by dedicated hardware.

FIG. 2 provides an exemplary detailed block diagram of a program 200 which determines a musical media file to retrieve in dependence on one or more correlations made with one or more desired pace values 294, 295, 296, 297 incorporated into a preestablished exercise regimen 290 and a musical beat rate 265 associated with a plurality of musical media files 255.

In another embodiment, correlations may further be made between a user's desired footfalls, gait, or bipedal rates 296 and the musical beat rate 265 of a musical media file 255 available to the portable media player 100 by determination of an actual stride length 215 rather than based on an estimated or default stride length 297. In such embodiments the determination of an actual stride length 215 may be determined based at least in part upon a determination of a current actual footfall rate 205 of the user.

The term footfall rate 205, 296 may be used interchangeably herein with gait rate and bipedal rate 205, 296 and is referred to generally in units of footfalls per minute (FPM). It should be noted that a user's actual footfalls 205 need not be detected directly at the user's foot 320B. In various exemplary embodiments, the sensor(s) 75A-E, 80 may be located upon the user's torso, for example upon his or her belt, and configured to detect accelerations induced by the user's gait related motions; the accelerations providing data indicative of the user's footfalls. The sensors 75A-E, 80 may also be located upon the user's head, torso, or limbs, and may likewise be configured to detect accelerations induced by the user's gait related motion; the accelerations providing data indicative of the user's footfalls, footfall rates, and/or footfall counts. Alternately, or in addition thereto, the actual footfall rate of the user may also be averaged 230 over a period of time to minimize influences caused by a user's momentary change in gait.

For example, a user may temporarily accelerate to cross a street and then return to a more characteristic pace. Random movements which do not fit a repetitious physical movement may be ignored. Filtering, threshold detection, and/or other signal processing mechanisms may be employed to suppress random or otherwise unwanted “noise” movements.

The actual current footfall rate 205 and/or actual stride length 215 of the user is generally determined using either motion sensors 75A-E, and/or the GPS receiver 80. The sensor data is captured while the user is walking, jogging, or running over a recent period of time. In embodiments utilizing accelerometers, the sensor data is generally processed for acceleration spike events that exceed a certain threshold to determine a footfall event. Such footfall events are counted and/or timed to determine current actual footfall counts and/or rates. Such actual footfall values 205 may be compared with desired footfall rates 296 and/or may be used to estimate actual stride lengths 215 and/or may be used to determine actual user progress though an discrete interval 291 of a preestablished exercise regimen 290.

The number of acceleration spike events per minute over a certain period of time can thus be calculated, indicating the average actual footfall rate 205 and/or actual stride length 215 for the user for that certain period. Sensors other than accelerometers 75 may be used in which case the spike events represent other forms of data but the calculation of actual footfall rate is still generally the same.

In embodiments utilizing the GPS receiver 80, actual spatial distances traversed may be determined along with accurate measurements of the user's actual footfall rate 205 and stride length 215. The actual spatial distances traversed may also be used to more accurately monitor the user's progress while performing the preestablished exercise regiment 290. This may also be used to compute the actual stride length 215 of the user. The GPS receiver 80 may be used in conjunction with the one or more sensors 75A-E to determine the actual stride length 215 values for a user as the user actually performs the preestablished exercise regimen. This embodiment generally provides the most accurate measurement of the user's performance when compared to the preestablished exercise regimen 290.

In another embodiment, the GPS receiver 80 may be employed singularly as the only sensor used for selecting musical media files 285. In this embodiment, the musical media files 285 may be selected based upon preestablished desired pace values 294, 295, 296 of the preestablished exercise regimen 290 and the distance to be traveled 292 incorporated into the preestablished exercise regimen 290 without requiring the actual footfall rates 205 of the user.

In a final embodiment, estimated values for the desired footfall rates corresponding to desired pace values 294, 295, 296 may be provided based on average (default) stride lengths of a given age group and/or gender and/or bodily height and/or leg length. Alternately the user may enter an estimated stride length value for based upon personal knowledge. For example, an average stride length of 5 feet 297 may be used to generate the desired footfall rate of a user based upon a preestablished pace values 294, 295 of the preestablished exercise regimen 290. The user may perform subsequent measurements and adjust the stored stride length 297 used to better match the user's actual stride length. A plurality of estimated stride length values 297 may be stored for a user, each estimated stride length value being associated with a different pace or range of paces for the user. This is because a user's estimated stride length may vary in somewhat predictable ways when a user is walking, jogging, and/or running at different paces. A lookup table, data array, and/or an algorithm may be used for determining an estimated stride length for the user when that user is performing a particular exercise pace. In general an accurate estimate of stride length for a user is highly desirable because stride length is an important value used in converting a desired spatial pacing value to a desired footfall rate of the user.

Alternatively the system may dynamically compute and/or update the user's stride length 215 based upon actual footfall data 205 from gait sensors used in combination with distance and/or speed data from GPS sensors. This is may be performed, for example, by dividing a distance traveled by the user, as determined from GPS data, by a number of actual footfalls 205 preformed by the user over that distance, as determined from gait sensor data. Alternately this may be performed by dividing an actual speed of the user 205, as determined from GPS data, by the actual footfall rate 205 of the user, for a particular time or distance interval. Such dynamic computing and/or updating of user stride length are highly desirable because stride length is an important value in converting a desired spatial pacing value to a desired footfall rate of the user. Thus an accurate stride length value is often critical in the selection and play of a musical piece with an appropriate beat rate.

In order to perform pace setting, the user selects and/or stores one or more preestablished exercise regimens 290 in a datastore 30 associated with the portable media player 100. Each exercise regimen 290 includes one or more sets of desired pace values 294, 295, 296. In an embodiment, each exercise regimen may also include one or more estimated stride length 297 values for the user. Alternately, a separate data file may be stored for the user that includes one or more estimated stride length values 297 for that user. For example, a single estimated stride length may be stored for the user in memory and/or stride length values for a variety of paces and/or pace ranges may be stored for the user. Alternately stride length values may be stored in a separate file that relate certain demographic statistics with stride length values and may be indexed based upon stored demographic statistics for the current user.

Generally, only one of the desired pace value 294, 295, 296 is required to use the intelligent pace setting features of the portable media player 100. Each desired pace value 294, 295, 296 indicates a desired rate of walking, jogging, or running which the user attempts to accomplish. The desired pace values 294, 295, 296 may be stored in various forms including but not limited to a desired number of footfalls per minute (FPM) 296, a desired speed 295, or a desired time to achieve a particular distance 294. Stride length values for the user may only be needed when desired pace values are stored in spatial terms, for user stride length relates user footfalls to user spatial progress. Generally, the program 200 stores desired pace values in spatial terms such as a desired speed 295 or a desired time to achieve a particular distance 294 because such values are more deterministic of exercise effort.

For example, a desired pace values 294, 295, 296 may be stored that indicates that the user performing the preestablished exercise regimen 290 should be moving with a pace of 106 footfalls per minute, 6.0 miles per hour, 8.8 feet per second, or a 10 minute mile. If the user's stride length is 5 feet 297 (meaning that he or she travels five feet forward with each footfall), each of these representations is roughly equivalent. For example 106 footfalls per minute translate to 106×5/60=8.8 feet per second.

Thus by storing one or more desired pace values in memory, the portable media player 100 may be used to select and play musical media files that motivate a user to maintain a desired pace as part of a preestablished exercise regimen. The preestablished exercise regimen 290 may comprise a set of desired pace values 294, 295, 296 over the duration of the walking, jogging, or running activity and generally allows specific pace values to be established for various intervals 291 associated with the preestablished exercise regimen 290. Each preestablished exercise regimen 209 may further includes a desired time duration 293 and/or a distance 292 that the pace is to be maintained. For example, the preestablished exercise regimen may describe a preestablished 5 mile run. The preestablished exercise regimen 290 may thus include a desired pace 294, 295, 296 for each of a plurality of intervals 291 of the five mile run for interval training. The intervals 291 may be regular, for example every half-mile or every ten minutes. The intervals 291 may also be irregular, each one independently defined. In this way a user can select or create an exercise regimen that assigns specifically desired pacing values for specific portions of the regimen. The program 200 may thus be configured to select and play those musical media files 255 for the user over the duration of the preestablished exercise regimen 290 that have a musical beat rate 265 that approximates the desired footfall rate 296 of the user required to achieve the target pace 294, 295, 296 stored in the preestablished exercise regimen 290. As such, the portable media player 100 may be configured to automatically select musical media files 255 for play during each interval 255 such that if the user runs at a pace such that his or her actual footfalls 205 approximates the primary of the musical beat rate 265, he or she should achieve the desired pace value 294, 295, 296. In this way, the portable media player 100 may automatically select musical media files 255 from the plurality of musical media files 285 stored in the datastore 30 that contain a primary beat which will assist the user to achieve the desired pace 294, 295, 296 for that interval 291 of the preestablished exercise regimen 290.

In an exemplary embodiment, the program 200 is operatively installed in the main memory 10 of the portable media player 100. The processor 5 receives the sensor signals from the one or sensors 75A-E and/or GPS receiver 80. The program 200 processes the incoming sensor signals to determine where within a current exercise regimen the user is currently performing. This may be based upon elapsed time, distance covered, tallied footfalls, or a combination thereof. Based upon this determination, the stored exercise regimen is accessed and a current pacing value 294, 295, 296 is retrieved. A desired footfall rate 296 of the user may then determined from the current pace value, the desired footfall rate of the user being that footfall rate which the user should approximately perform to achieve the desired current pacing value. A musical media file is then selected and played to the user by the portable media player such that the primary audible beat rate of the musical piece substantially matches the desired footfall rate. In this way a user who exercises such that his or her footfalls matches the beat rate of the music will approximately achieve the desired pacing value.

The desired footfall rate 296 is generally determined based upon one or more pacing values 294, 295, 296 for the current interval of the preestablished exercise regimen along with a current stride length 215, 297 for the user. In an embodiment where the actual stride length 215 of the user is used, the value is updated based upon sensor data, thereby accommodating changes in user stride length 215 during an exercise period due to fatigue, road conditions, and/or terrain inclination. Sensor data and/or GPS data may also be used by program 200 to determine which interval of the current exercise regimen the user is currently performing. This is generally achieved by tracking the time, distance, and/or footfall count progress through a preplanned exercise regimen. For example, if a GPS sensor 80 is used, the GPS data may be used to determine spatial distance progress through a current exercise regimen. GPS data in combination with stride length data may be used to determine footfall count progress through a current exercise regimen. Gait sensor data may alternately be used to determine footfall count progress through a current exercise regimen. Clock data may be used to determine temporal progress through a current exercise regimen. In such ways program 200 may determine which interval, as well as where within an interval, the user is currently performing as he or she progresses through an exercise session. By tracking such progress through the preestablished exercise regimen, the program 200 may determine which pacing value to use when selecting a musical file for current play to the user as he or she performs the preestablished exercise regimen.

The program 200 performs the correlations 207 to select from the plurality of musical media files 285 those musical media files 281, 282 having the closest correlation(s) with the desired footfall rate 296 of the user determined from at least one of the desired pace values 294, 295, 296 associated with a current interval of the preestablished exercise regimen. For example, a desired footfall rate of 106 footfalls per minute 298 is more closely correlated to a musical beat rate of 110 beats per minute 266 for musical media file 1 281, than to other musical beat rates 265 of other musical files 2,N 282, 283. As such, musical media file 1 281 is selected or otherwise assigned to at least a portion of interval 1 291 of the preestablished exercise regimen 290 and played to the user when he or she performs that interval. In this way the user, by running such that his or her actual footfalls 205 substantially match the music beat rate 265, the user will more easily maintain a pace at or near the desired pace of 106 footfalls per minutes 298 for at least a portion of the time duration 293 of 5 minutes as a warm-up period. The minor differences between the desired pace value 296 of 106 footfalls per minute and the musical beat rate of 110 beats per minute 266 may be compensated for by applying a tempo adjustment 235 which allows an adjustment of +/−20% 240 in the playback speed. The tempo adjustment is applied continuously 245 throughout the play back of the musical media file 2 281. A pitch adjustment 250 may be necessary to correct for the change in playback speed.

For the second interval 291, a faster pace is established which requires a desired footfall rate 296 of approximately 176 footfalls per minute 299. In this example, the musical media file 2 282 which musical beat rate of 270 of 185 beats per minute 267 is closer in correlation than other musical media files 1,N 281, 283. As such, musical media file 2 282 is selected or otherwise assigned to at least a portion of interval 2 291 of the preestablished exercise regimen 290 and played to the user during his or her performance of that interval 291 to maintain the approximate pace of 176 footfalls per minute 299 for at least a portion of the time duration of 10 minutes 293 as a training period. The minor differences between the desired pace value of 176 footfalls per minute 299 and the musical beat rate of 185 beats per minute 267 may be compensated for by applying a tempo adjustment 235 which allows an adjustment of +/−20% 240 in the playback speed. The tempo adjustment is applied continuously 245 throughout the play back of the musical media file 2 282. A pitch adjustment 250 may be necessary to correct for the change in playback speed.

In some situations, the duration of the musical media files may not match the transition points in the intervals 291 of the preestablished exercise regimen 290. To accommodate this situation, the program 200 may be configured to terminate a musical media file early by fading out the volume and then play a newly selected musical media file that has the musical beat rate of the new desired footfall rate as provided by the preestablished exercise regimen.

Alternately, the program 200 may be configured to complete the play of a currently playing musical media file beyond a transition point of an exercise interval 291, and then begin the play of the newly selected musical media file thereafter. This will result in discrete exercise intervals varying by some small amount of time, generally up to a few minutes for a long musical media file, but it may be more pleasurable for some users. In an embodiment, the program 200 may be configured to modify the playback rate or tempo of the currently playing musical file once it extends beyond the transition point of an exercise interval 291, the modified tempo or playback rate being performed such that the musical beat rate of the currently playing musical media file more closely corresponds to the new desired footfall rate of the new exercise interval 291.

In general, this tempo or playback rate adjustment is performed gradually over a period of time so that it is not particularly audibly noticeable to the user. In this way a musical media file may continue to play past the transition point of an exercise interval 291 without interruption but may be adjusted in tempo to gradually ease the user towards the new desired footfall rate of the new exercise interval. Depending on how large of a change in desired footfall rate caused as a result of the transition to the new exercise interval, the tempo shift may or may not fully achieve a beat rate that matches the new desired footfall rate. If not, the new desired footfall rate will be achieved upon completion of the playing musical media file and the selection of a next musical media file. Still the tempo shift motivated the user part way to the desired footfall rate, easing the transition when the new musical media file is finally played.

The program 200 may also be configured to select musical media files 285 with consideration of their duration such that they better fit within the timing of the preestablished exercise regimen. In this situation, the musical media files that have durations that alone or in combination with others meet the timing requirements of an interval 291 of a preestablished exercise regimen 290 may be more highly weighted in the weighted random selection process. For example, musical media files of short duration may be more highly weighted as a preestablished exercise regimen interval 291 nears completion because a short duration musical media file will run over the interval boundary by a shorter amount of time.

Lastly, the program 200 may be configured to automatically select musical media files 285 for play with a musical beat rate 265 that approximates the desired footfall rate 296 such that it is configured to select musical media files for play in real time, (i.e., as the user executes the planned exercise regimen.) Alternately, the program may be configured to automatically select the appropriate musical media files in advance, the program 200 automatically generating a full or partial play list of musical media files 285 for the preestablished exercise regimen 290. An advantage of the real time embodiment is that the system may select musical media files 285 based upon the actually detected progress of the user throughout the preestablished exercise regimen 290 rather than a prediction of how the user will progress through the preestablished exercise regimen. Another advantage of the real time embodiment is that the system may select musical media files based upon the actually detected and updated actual stride lengths 215 of the user as the user performs the preestablished exercise regimen rather than a predicted stride length 297 of the user. Because a user's rate of progress through a preestablished exercise regimen and/or actual stride length 215 may vary considerably from the preestablished exercise regimen 290, the real-time music selection embodiments may provide significantly more accurate pace setting music selections to help a user perform a desired exercise regimen.

In addition, minor differences between the desired pace value 294, 295, 296 and the users actual pace 205 may likewise be compensated for by applying the tempo adjustment 235 which allows an adjustment of +/−20% 240 in the playback speed. The tempo adjustment is applied continuously 245 throughout the play back of the musical media file 2 282. A pitch adjustment 250 may be necessary to correct for the change in playback speed. In an embodiment, the tempo 235 may be increased to acoustically motivate the user to increase his or her pace to help meet the desired goal.

In an embodiment, approximate correlations 207 may be performed between the desired footfall rate 296 and one or more of the musical rates 265 using an allowable tolerance range and/or an approximate whole number multiple of the footfall rate 296 for selection of one or more musical media files 285 for play from an available datastore 30.

For example, a desired footfall rate 296 may correlated with one or more musical beat rates 265 if the desired footfall rate 296 is within 5% of one or more of the musical beat rate 265. In some such exemplary embodiments, the closer the desired footfall rate 296 is to the musical beat rate 265, the higher a computed correlation factor.

Similarly, a desired footfall rate 296 may be correlated with a musical beat rate 265 if half the desired footfall rate 296 is within 5% of one or more of the musical beat rate 265. In some such exemplary embodiments, the closer that half the desired footfall rate 296 is to the musical rate 265, the higher a computed correlation factor. Analogously, a desired footfall rate 296 may correlated with one or more musical beat rates 265 if double the footfall rate is within 5% of one or more of the musical rates 265.

In some such exemplary embodiments, the closer that double the desired footfall rate 296 is to the musical rate, the higher a computed correlation factor. Alternately, a higher correlation factor may be computed when the desired footfall rate 296 is within certain proximity of a musical rate as compared to half or double the desired footfall rate 296 being within the same proximity of musical beat rate 265. This is largely dependent on a particular user's preference. For example, one user may find it perceptually pleasing to be walking, jogging, or running, with a desired footfall rate 296 that is within close temporal proximity of half or double the audible musical beat rate 265. Other users may find it more perceptually pleasing to be walking, jogging, or running with a desired footfall rate 296 that is within close temporal proximity of the actual audible musical beat rate 265.

The musical beat rate 265 is the average number of beats per minute (bpm) in a musical media file (or a portion thereof.) The beats per minute for a particular musical media file 285 may be predetermined and accessed from an attribute or data file associated with a particular musical media file 285 or may be derived from the musical content of the musical media file 285 itself during playback or a the time of storage. The musical beat rate 265 of a musical media file 285 may be determined by processing the musical content contained in the musical media file 285, for example, by timing the number of pronounced rhythmic events (referred to hereinafter as attack events) in the musical content.

In another example, the musical beat rate 265 may be determined to be 100 for a particular musical content and the desired footfall rate 296 may be determined to be 50 as shown in the current example. Since 100 is a whole number multiple of 50 (in this case the whole number=2), a musical beat rate correlation may be determined and used to select a particular musical media file 285 for play. The musical beat rates 265 for various musical media files 281, 282, 283 may be obtained from web-based service providers. For example, a large number of musical media files and is found at the uniform resource location (URL) of www.bpmlist.com. This and other similar websites and services provide a listing of musical media files by title, artist, index, and/or genre, and relationally associate each musical media file to its previously determined musical beat rate 265 value.

The musical beat rate 265 of a musical media file 285 may also be determined by the number of beats per minute for attack events in different frequency bands of the musical content. A plurality of musical beat rates 265 parameters may be derived for attack events that exceed different amplitude levels which may be segregated into high amplitude beats per minute and low amplitude beats per minute. In addition, processing techniques are available to determine and/or infer a perceptually dominant musical beat rate 265 for a piece of musical content from among a plurality of musical beat rates 265 derived from a particular piece of musical content. This may be accomplished, for example, using relative frequency bands and/or amplitude levels of the attack events for each of the plurality of musical beat rates 265. The perceptually dominant musical beat rate 265 is that which the user is likely to perceive most profoundly when listening to the music.

The musical beat rate of a musical piece can be derived by analyzing the music data profile and identifying a characteristic rhythm rate, thereby indicating a most salient primary musical beat rate for the music piece. Such techniques, generally referred to as “audio tempo extraction” are known the art. For example, the 2004 technical paper, “Deviations from the resonance theory of tempo induction,” published at the Conference on Interdisciplinary Musicology,” by McKinney and Moelants, describes such a method and is hereby incorporated by reference. Another example, the 2004 technical paper, “Extracting The Perceptual Tempo From Music,” by McKinney and Moelands published at ISMIR 2004 5th International Conference on Music Information Retrieval, also describes such methods of automatic audio tempo extraction and is hereby incorporated by reference.

A weighted random selection process may be used to select a musical media file from a plurality of available musical media files 285, the weighted random selection process configured such that the selection of certain musical media files 281, 282, 283 is more likely than the selection of other musical media files 285 based at least in part upon the correlations between the currently desired footfall rate 296 of the user and one or more musical beat rates 265 associated with the musical media files 281, 282, 283.

For example, a weighted random selection process is employed such that musical media files 281, 282, 283 are more likely to be selected by the random selection process if their musical beat rate 265 that more closely matches the currently desired footfall rate 296 of the user. The weighted random selection process may also be configured to randomly select only among those of the plurality of musical media files 281, 282, 283 that have a musical beat rate 265 that falls within certain proximity of the currently desired footfall rate 296 of the user.

This may be achieved by weighting those musical media files 281, 282, 283 that have a musical beat rate 265 that are significantly different from the desired footfall rate 296 of the user to 0 such that the odds of those musical media files being selected is 0. For example, the weighting of musical media files 281, 282, 283 in the plurality of musical media files 285 that have a musical beat rate 265 that is more than 7.5% different than the currently desired footfall rate 296 of the user will have a weighting set to 0 such that they will have no chance of being selected. The selection range may be varied to accommodate a smaller or larger proximity range.

In an exemplary embodiment, musical media files 281, 282, 283 having a musical beat rate 265 within certain proximity of double the desired footfall rate 296 may also be set to a non-zero weighting such that these a musical media files 281, 283 may be selected by the weighted random selection routine.

In another exemplary embodiments, the musical media files 281, 282, 283 having a musical beat rate 265 within certain proximity of half the desired footfall rate 296 may also be set to a non-zero weighting such that these musical media files 281, 282, 283 may also be selected by the weighted random selection process.

In another exemplary embodiment, the weighted random selection process may be configured to select a musical media file 281, 282, 283 at random from the plurality of available musical media files 285 in memory, but may be configured to only select among those musical media files 285 that have a musical rate(s) 265 that approximates the desired footfall rate 296 of the user for the current interval of the preestablished exercise regimen. Additional related embodiments of a weighted random selection process for musical media files are described in the instant inventor's co-pending U.S. patent application Ser. No. 11/223,386 filed Sep. 9, 2005; Ser. No. 11/298,434 filed Dec. 9, 2005; Ser. No. 11/354,667 filed Feb. 14, 2006; and Ser. No. 11/367,178 filed Mar. 2, 2006 which are herein incorporated by reference in their entirety as if fully set forth herein.

In another exemplary embodiment, a multiple of the desired footfall rate 296 may be used to determine a musical media file for play, either through direct selection or through a weighted random selection process. For example, a doubling of the footfall rate 296 may be used in the musical media file selection process when correlating with musical beat rates 265.

In another exemplary embodiment, dividing the desired footfall rate 296 by two may be used to determine a musical media file for play, either through direct selection or through a weighted random selection process. For example, the user may actually be running with a footfall rate of 100 footfalls per minutes 205. As a result the media selection process may select for play, or more heavily weight for selection, a musical media file 285 with a musical beat rate of 50 beats per minute.

In yet another exemplary embodiment, additional selection criteria may be considered. For example, a play history 275 and/or a selection weighting factor 280 may be used to further refine the musical media file 285 selection. A play history 275 may indicate, for example, how recently the user may have listened to the associated musical media file 281, 282, 283, the larger the number, the less recently it has been listened to. A weighting factor 280 may indicate, for example, how partial the user may be to the particular musical media file, a large number indicating that the user is highly partial to the musical media file 281, 282, 283.

In this example, musical media file 1 281 having both the higher play history 275 value of 30 and a higher selection weighting factor 280 value of 0.3 would be selected over (or more heavily weighted in the random selection process than) musical media file N 283 whose play history 275 and selection weighting factor 280 having respective values of 10 and 0.1 which are both less than those of musical media file 1 281. In this manner, the selection processes may be configured to automatically select musical media files for a user from a plurality of available musical media files such that the selected musical media file is likely to be one that; has a musical rate 265 that closely matches the currently desired footfall rate 205; has not been listened to very recently and/or; the user is preferred over other musical media files 281, 282, 283.

To simplify the identification and retrieval of the selected musical media file 285, a unique identifier ID 255 associated with each musical media file 281, 282, 283 available for selection from the datastore 30 may be used as a relational index. The unique identifiers 255 are pre-assigned and may be stored in an array for rapid selection and loading of the selected musical media file 285 into a media play queue 260.

Once the musical media file 285 is selected and begins playback, it may be automatically adjusted 265 in playback speed such that it is played back at a rate slightly faster or slower than the nominal rate to better match and/or maintain the match between the audible musical beat 265 in the currently playing music file and the desired footfall rate 296 associated with the desired pace value of a current interval 291 of a current exercise regimen. For example if the nominal musical beat rate 265 of is slightly slower than the desired footfall rate 296, the playback speed of a musical media file 285 may be increased and thereby raise the musical beat rate 265 of the music heard by the user so that if the user runs to the music, he or she will better match the desired footfall rate 296 associated with a desired pace 294, 295, 296 of a current interval 291 of the current exercise regimen 290.

Analogously, if the nominal musical beat rate 265 is slightly faster than the desired footfall rate 296, the playback rate of a musical media file 285 may be decreased and thereby slow the musical beat rate 265 heard by the user so that if the user runs to the music, he or she will better match the desired footfall rate 296 associated with a desired pace 294, 295, 296 of a current interval 291 of the current exercise regimen 290. Such adjustments may be performed to accommodate slight deviations between the nominal beat rate of the selected musical media file and the desired footfall rate. For example, if the desired footfall rate is 70 footfalls per minute and the beat rate of the selected musical media file is 72 BPM (beats per minute), the selected musical media file may be played tempo-adjusted such that the play rate is slowed to 97.5% of its nominal rate. This will slow the audible beat rate heard by the user from 72 BPM to 70 BPM, thereby motivating a user who runs to the beat of the music to better achieve the desired footfall rate.

Such adjustments may be alternately performed to accommodate variations in the user's stride length 215 during a preestablished exercise regimen 290. For example, if a user is running to the musical beat rate but his or her actual stride length 215 decreases below the expected value 297, the user may fall below the desired pace 294, 295, 296 even though his footfalls are matching the musical beat rate 265.

To address this situation, the program 200 upon detecting the drop in the user's stride length 215 may increase the playback rate 235 of the currently playing musical media file 285 by an appropriate amount such that the user will better achieve the desired pace value pace 294, 295, 296 for the current interval 291 of the current exercise regimen 290. Similarly, if a user is if a user is running to the musical beat rate but his or her stride length increases 215 to above the expected value 297, the user may be going faster than the desired pace 294, 295, 296 even though his footfalls are matching the musical beat rate 265. To address this situation, the program 200 upon detecting the increase in the user's stride length 215 may decrease the playback rate 235 of the currently playing musical media file by an appropriate amount such that the user will better achieve the desired pace value pace 294, 295, 296 for the current interval 291 of the current exercise regimen 290. In this way, a user may be assisted at a achieving a particular pace 294, 295, 296, for example in miles per hour or feet per second, even when his or her stride length 215 is varying from an expected value 297 during a particular interval 291 of a particular exercise regimen 290. In many such embodiments the playback speed of the music is gradually increased or decreased such that the user may not even notice the change 235. In this way the user is coaxed back to the desired pace value pace 294, 295, 296 in a gradual manner if he or she has inadvertently strayed as a result in a change in stride length 215.

In an exemplary embodiment, the program 200 accomplishes the playback adjustment 235 in the playing of musical media files by performing a tempo-shifting 235 operation. The tempo shifting operation 235 adjusts the playback rate of the currently playing musical media file 285 to be increased or decreased relative to a nominal playback rate to better match the desired footfalls 296 of the user and/or the desired pacing value pace 294, 295, 296 of the current interval 291 of the current exercise regimen 290. The variation in playback speed is generally limited to a maximum of plus or minus 20% 240 to prevent undue distortion of the perceptionally adjusted output 210 supplied to the user.

In a related exemplary embodiment, an audible pitch-adjusting operation 250 is applied to the tempo adjusted playing musical media file 250 to improve the overall audio quality of the perceptionally adjusted output 210 supplied to the user. The audible pitch-adjusting operation 250 is performed on the playing musical media file 285 such that the audible pitch remains generally near normal levels despite the increase or decrease in playback speed, thus compensating for the variation in playback. As such, the perceptionally adjusted output 210 sounds substantially similar to normal playback with only a subtle change in play speed being imparted by the portable media player 100.

In general, the user will hardly notice the change in playback speed, especially if the program imparts the tempo adjustment 235 and pitch adjustment 250 operations gradually over time. However the user will gain an improved exercise experience because of the greater synchronization between the desired footfalls 205 and the musical beat rate 265 of the playing musical media file 285. Lastly, the tempo adjustment 235 and audio pitch adjustment 250 are provided iteratively 245 during play to maintain apparent synchronicity with the exercise pacing, for example if the user's stride length 215 changes during the play period of the musical media file.

With respect to the specific technical mechanisms by which the playback speed of a musical media file may be increased or decreased from a nominal playback speed and by which the audible pitch may be maintained at substantially normal audible pitch ranges, are known in the relevant art of audio signal processing. For example, a method for changing tempo without changing audible pitch is disclosed in U.S. Pat. No. 6,686,531 which is hereby incorporated by reference. Additional methods of adjusting the audible pitch and tempo of a musical signal are disclosed in U.S. Pat. Nos. 5,952,596 and 5,728,960 which are both hereby incorporated by reference.

In addition, commercially available software exists that performs such tempo-shifting and audible pitch-shifting functions. For example, commercially available software called PCDJ Red Virtual Rack Module by Visiosonic of Clearwater, Fla., found at the uniform resource location (URL) of www.visiosonic.com. This equipment has the capability to scan a musical media file 285 and determine the tempo in beats per minute. This software also has the ability to speed up or slow down the rate of play of the music file away from the normal rate by up to plus or minus 20% to avoid introducing noticeable distortion of the playing musical media file 285. The software may also perform an audible pitch shift operation 250 such that it sounds are not altered in perceivable audible pitch despite the speed change in playback away from the normal playback speed.

With respect to the specific technical methods by which tempo and/or rhythm values may be derived automatically from musical content, a wide variety of methods are known in the relevant art of audio signal processing and therefore needs not be described in detail herein. For example, U.S. Pat. No. 6,323,412 discloses a system and methods for automatic tempo detection from a musical audio signal and is hereby incorporated by reference in its entirety. Similarly, U.S. Pat. Nos. 5,614,687 and 6,812,394, which are likewise incorporated by reference in their entirety, disclose methods and apparatus by which musical content may be processed such that a tempo rate 270 may be derived and returned.

Referring to FIG. 3, an exemplary detailed block diagram of a user 300 providing repetitive physical movements 350A-D which are detected by a sensor 75A-E and processed by a portable media player 100 to select and play a musical media file 250 based at least in part on approximate matches between the user's footfall rate 205 with one or more musical rate correlation parameters of the musical media file 281, 282, 283.

In a first exemplary embodiment, a portable media player 100 is equipped with an internal gait sensor (accelerometer) 75A. The sensor 75A may be a single or multi-axis accelerometer. If a single axis accelerometer is installed, the sensing axis 350B of the accelerometer 75A is generally orientated to detect accelerations imparted by the user along the lengthwise axis of the portable media player 100. In such exemplary embodiments, the portable media player 100 may generally be worn or otherwise affixed to the user's body such that the lengthwise axis is aligned substantially with the real-world vertical axis when the user 300 is standing upright. For example, the portable media player 100 may be affixed to a user's belt with and oriented about the user's waist. When so oriented, the single axis accelerometer 75A within the portable media player 100 housing may detect vertical accelerations induced by the user's gait.

In this way, the sensing axis 350B detects the up and down repetitive movements of the user 300 as she walks, jogs, or runs over the terrain 325. The program discussed above is configured to process the acceleration data and will detect the most common up/down accelerations of the user's body imparted by a walking, jogging, or running gait. If a multi-axis accelerometer is used, the portable media player 100 may be held, worn, or otherwise affixed with respect to the body in a wider variety of orientations. For example, the portable media player 100 my be affixed to an arm 305 of the user 300 which will produce primarily lateral and/or tangential accelerations 350C as the user's arm 305 swings forward and backward as the user runs across the terrain 325 while performing typical gait-related motions.

Alternately, one or more external sensors 75B-E may be disposed on the headset 65A or remote display 25A, wrist 310, shoe 320B or ankle 320A to detect physical repetitive movements 350A, 350C-F. Preferably, the remote sensors 75B-E are in processing communications with the portable media player 100 using wireless communications 85. As is apparent, the type of sensor 75A-E is dependent on the type of physical repetitive movements to be detected. In general, a single or double axis accelerometer should provide acceptable repetitive motion detection. Triple axis accelerometers may also be used as one of the sensors 75A-E.

Lastly, the portable media player 100 may equipped with a GPS receiver 80 which may used to track a user's progress through a current exercise regimen and thereby determine which interval of the regimen the user is currently performing. The GPS sensor may also be used in conjunction with the other sensors 75A-E to determine the current stride length 215 of the user 300. The GPS receiver 80 may be configured to terrain inclinations and declinations traversed by a user. In other embodiments an inclinometer, accelerometer, and/or magnetometer is used to detect the terrain inclination currently being traversed by a user.

FIG. 3A depicts an exemplary detailed block diagram of a portable media player configurable with internal sensor(s) 75A, 80A and/or external sensor(s) 75B, 80B. In this exemplary embodiment, the internal sensor(s) 75A, 80A are installed within the housing of the portable media player 100. The repetitive motions or spatial displacements made by a user 300 while running, jogging or walking should be sufficient to provide acceptable signals to the internal processor 5.

For example, when the portable media player 100 is worn on about the waist or otherwise affixed to the torso, head, or other body part that undergoes vertical up and down motions 350B during typical gait actions, the sensor 75A will capture data characteristic of repetitive gait motions. Such motions are generally referred to as footfalls, although they may not directly represent the actual footfall action but rather a corresponding body action. Such data can be used to detect and count footfall events. An accrued footfall count for a user may be used alone, or in combination with stride length data, to track a user's progress through a current exercise regimen and thereby determine which interval of the regimen the user is currently performing.

In some embodiments gait sensor 75A is used in combination with GPS receiver 80 by the program 200 to determine a gait rate, stride length, and/or progress through a current exercise regimen. In an alternate exemplary embodiment, one or more external sensors 75B, 80B may be coupled directly to the portable media player 100 using the docking port associated with the communications interface 55. A counterpart plug assembly 55′ which mates with the docking port is provided. This exemplary embodiment provides an aftermarket alternative to integrating an internal sensor 75A, 80A or requiring wireless communications 85 between the portable media player 100 and the various motion sensors 75C-E discussed above.

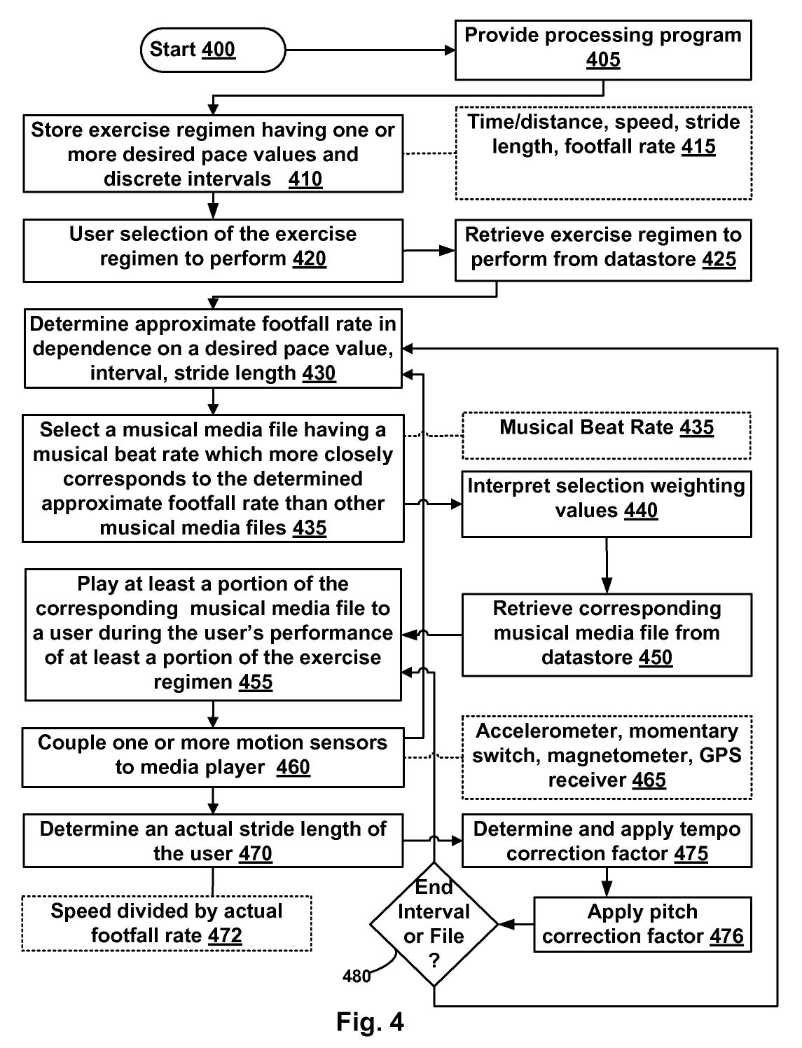

FIG. 4 depicts an exemplary flow chart of a process for the automatic selection and playing of musical media files with beat rates which approximately matches the desired footfall rate of a user as the user performs a preplanned exercise regimen.

The process is initiated 400 by providing a program configured to intelligently select and play a musical media file 405 on a portable media player in accordance with a preestablished exercise regimen preestablished by the user. The preestablished exercise regimen is stored in a memory of the portable media player 410. The preestablished exercise regimen includes one or more user desired pace values for example, a specific time for the user to traverse a distance, a certain speed, a certain footfall rate 415.

When the user is ready to perform a preestablished exercise regimen, he or she selects 420 the preestablished exercise regimen which then retrieved from the memory 425. The program determines a first desired approximate footfall rate based on a first desired pace value of the preestablished exercise regimen. In various embodiments other values such as the user's stride length may be used to determine the desired approximate footfall rate needed to meet the user's desire pace 430. The user's stride length may be a previously stored value, a user entered value, a value determined based on demographic statistics, a dynamically determined value based upon sensor data, or a combination thereof.

The program then determines which of a plurality of accessible musical media files include a musical beat rate which more closely corresponds to the determined approximate footfall rate 435 than other of the plurality of accessible musical media files. In an embodiment, the program further determines which musical media file to select based on weighting factors. The weighting factors provide an indication of the popularity of a particular musical media file to the user, how recently and/or often the user may have listened to a particular musical media file, and the suitability of the duration of the musical media file to the needs of the preestablished exercise regimen. Thus, even though a musical media file may meet the approximate footfall rate criteria, the musical media file may be rejected based on a low weighting factor score 445. In another embodiment, a musical media file may be selected directly or weighted for selection in a weighted random selection process.

Once the musical media file determination process has been completed, the program then retrieves the first musical media file from memory which more closely corresponds to the determined desired pace usually converted to an equivalent footfall rate 450.

The selected musical media file is then retrieved from memory and played 455 when the user performs the corresponding portion of the preestablished exercise regimen. In an embodiment, the length of an exercise interval is taken into consideration. For example, an exercise interval of 5 minutes would generally cause the program to select a musical media file or a combination of musical media files which approximates this time frame in conjunction with corresponding approximate footfall rate and weighting factors.

While the above process describes the selection of a first musical media file, the process generally repeats such that a plurality of musical media files are played to the user as he or she progresses through the preestablished exercise regimen. In this way, the intelligent pace-setting media player is operative to select and play a plurality of media files in sequence to the user such that the audible beat rate of the playing music substantially matches the desired footfall rate of the user as he or she progresses through the preestablished exercise regimen. As described previously, musical media files may be played at their nominal play speed if the beat rate closely matches the desired footfall rate. Alternately musical media files may be tempo-adjusted such that their audible beat more closely matches the desired footfall rate. As also described previously, the musical media files may be tempo-adjusted to account for deviations in user stride length from an expected value. In these ways, a plurality of musical media files may be automatically selected, played, and optionally tempo adjusted, in sequence, to provide a musical beat to a user who is performing a preestablished exercise regimen that helps the user approximately achieve a desired pace prescribed by the preestablished exercise regimen.

The portable media player may be worn or otherwise affixed to a user's body. In an embodiment, one or more sensors 465 may be coupled to the portable media player 460 to detect characteristic repetitive gait motions as a time varying sensor signal. The sensors may be a single or multi-axis accelerometer, magnetometer, GPS receiver, momentary switch or pressure switch configured to detect motions and/or geospatial displacements induced upon the sensors by a user running, walking or jogging. This information may be used to determine the user's actual stride length 470 which allows for adjustment of the rate of playback of the musical media file. The stride length may be calculated by dividing the speed of the user by the actual footfall rate of the user 472. Alternative methods may be used to calculate the user's stride length as well.

For example, the motion sensors may be further used to determine and apply terrain inclination factors 470 such that the beat of the playing music is sped up or slowed down to account for the user traversing a steep hill or other incline. For example, if the user is running uphill, the desired pace may be too great for the user to maintain and the program slows the tempo of the playing musical media file to assist the user in negotiating the hill. Conversely, if the user is running downhill it may be difficult for the user to maintain a particular pace without going faster under the pull of gravity. In such a situation, the program may increase the tempo.

In a related exemplary embodiment, a tempo adjustment factor may be applied to increase or decrease the tempo of the currently playing musical media file to achieve a better match between the desired footfall rate of the user and the musical beat rate of the musical media file 475. The tempo adjustment factor may be gradually applied during the play of the musical media file in order to minimize perceivable changes to the user. In an embodiment, a pitch correction factor may be applied to the playing musical media file in which the tempo adjustment factor has been applied 476.

In a final embodiment, if the program encounters an end of an exercise interval, the program loops back to determine a new approximate footfall rate for the next interval selected by the user 430. Alternately, if the current interval is lengthy, for example a 10 mile run and a currently playing musical media file 480 reaches its end, the program selects another musical media file which will provide a similar footfall rate as the musical media file which just ended. If no end event has been encountered by the program, the currently playing musical media file continues playing 480.

The various exemplary embodiments described herein are merely illustrative of the principles underlying the inventive concept. It is therefore contemplated that various modifications of the disclosed exemplary embodiments will, without departing from the spirit and scope of the various exemplary inventive embodiments will be apparent to persons of ordinary skill in the art. In particular, it is contemplated that functional implementation of the various exemplary embodiments described herein may be implemented equivalently in hardware, software, firmware, and/or other available functional components or building blocks.

What is claimed:

1. A system for intelligently selecting and playing musical media files on a portable media player in accordance with a preestablished exercise regimen comprising:
a processor associated with the portable media player;
a main memory functionally coupled to the processor;
a secondary memory functionally coupled to the processor; the secondary memory having retrievably stored therein;
the preestablished exercise regimen including; a desired pace value to which a user desires to maintain for a discrete interval, the desired pace value having a determinable relationship to an approximate footfall rate of the user;
a plurality of musical media files, each of which including a musical beat rate associated therewith;
a program operatively loadable into the main memory having instructions executable by the processor to;
retrieve the preestablished exercise regimen from the secondary memory;
determine the approximate footfall rate of the user in dependence on at least the desired pace value;
select a musical media file from the plurality of musical media files in the secondary memory based at least in part upon the selected musical media file having a musical beat rate which more closely corresponds to the approximate footfall rate than other of the plurality of musical media files;
retrieve the musical media file from the secondary memory whose musical beat rate more closely corresponds with that of the approximate footfall rate; and,
play at least a portion of the retrieved musical media file to the user during the user's performance of at least a portion of the discrete interval of the preestablished exercise regimen to which the desired pace value corresponds.

2. The system according to claim 1 wherein the preestablished exercise regimen is divisible into a plurality of discrete intervals, each of which having a desired pace value associated therewith.

3. The system according to claim 2 wherein the discrete interval is one of; a time interval, a distance interval, a number of footfalls, and any combination thereof.

4. The system according to claim 1 wherein the desired pace value is one of; a footfall rate, a time to achieve a specific distance, a speed and any combination thereof.

5. The system according to claim 1 wherein each of the plurality of musical media files is further associated with one or more weighting values; the one or more weighting values being indicative of a selection preference of the user.

6. The system according to claim 5 wherein the program further includes instructions executable by the processor to select the musical media file in further dependence upon the one or more weighting values.

7. The system according to claim 1 wherein the approximate footfall rate of the user is dependent at least in part upon a stride length of the user.

8. The system according to claim 7 wherein the stride length is entered by the user.

9. The system according to claim 7 further including one or more motion sensors, each of the motion sensors being operative to transmit motion signals to the processor indicative of one of; a current location, a distance traveled, a speed traveled, and any combination thereof, which is induced by dynamic movements of the user.

10. The system according to claim 9 wherein the program further includes instructions executable by the processor to dynamically determine an actual stride length of the user from the received motion signals.

11. The system according to claim 9 further including a gait sensor, the gait sensor being operative to transmit gait signals to the processor indicative of an actual footfall rate, an actual footfall count, and any combination thereof, which is induced by dynamic movements of the user.

12. The system according to claim 11 wherein the program further includes instructions executable by the processor to dynamically determine an actual stride length of the user based at least in part on the received gait signals.

13. The system according to claim 11 wherein the program determines the actual stride length of the user by dividing a determined distance traveled of the user by the actual footfall count of the user.

14. The system according to claim 11 wherein the program determines the actual stride length of the user by dividing an actual speed of the user by the actual footfall rate of the user.

15. The system according to claim 2 wherein one of the plurality of discrete intervals includes a current discrete interval, the current discrete interval having associated therewith, the desired pace value to be used in selecting a musical media file for current play to the user.

16. The system according to claim 15 wherein the program further includes instructions executable by the processor to set a next discrete interval of the preestablished exercise regimen as the current discrete interval is completed by the user.

17. The system according to claim 16 wherein the user's completion of the previous current discrete interval is determined based at least in part upon one or more sensor signals indicative of the user's location, distance of travel, speed of travel, footfall count, footfall rate, elapsed time, and any combination thereof.

18. The system according to claim 17 wherein the program further includes instructions executable by the processor to select a next musical media file for play to the user in dependence on one of, a completion of play of a current musical media file, a completion of the current discrete interval, and any combination thereof.

19. The system according to claim 1 further including an inclination sensor functionally coupled to the processor; the inclination sensor being operable to transmit signals to the processor indicative of a non-level terrain inclination currently being traversed by the user.

20. The system according to claim 19 wherein the program further includes instructions executable by the processor to apply a tempo adjustment factor to the musical media file, the tempo adjustment factor being based at least in part on the inclination sensor signals and applied to retrieved musical media file during play, so as to compensate for deviations in the desired pace value resulting from the user's traversal of the non-level terrain inclination.

21. The system according to claim 20 wherein the tempo adjustment factor varies a play back rate of the retrieved musical media file during play such that if the user approximately matches his or her footfall rate to a tempo-adjusted musical beat, the user will generally achieve the desired pace value.

22. The system according to claim 20 wherein the program further includes instructions executable by the processor to apply an audible pitch adjustment factor to normalize an audible pitch of the retrieved musical media file during play, in which the tempo adjustment factor has been applied.

23. The system according to claim 1 wherein the program further includes instructions executable by the processor to apply a tempo adjustment factor to the retrieved musical media file during play, the tempo adjustment factor varying a tempo of the retrieved musical media file during play such that the musical beat rate more closely corresponds to the approximate footfall rate.

24. The system according to claim 10 wherein the program further includes instructions executable by the processor to determine if the actual stride length of the user has varied during the play of the retrieved musical file; the program compensating for the variations in the actual stride length by varying a tempo of the musical media file during play such that the musical beat rate provides an opportunity for the user to achieve compliance with the desired pace value.

25. A method for intelligently selecting and playing musical media files on a portable media player in accordance with a preestablished exercise regimen comprising:
providing instructions executable by a processor associated with the portable media player for programmatically;
retrieving the preestablished exercise regimen from a secondary memory functionally coupled to the processor;
determining an approximate footfall rate for a user in dependence on at least a desired pace value included in the retrieved preestablished exercise regimen;
selecting a musical media file from the plurality of musical media files stored in the secondary memory based at least in part on the selected musical media file having a musical beat rate which more closely corresponds to the approximate footfall rate than other of the plurality of musical media files;
retrieving the selected musical media file from the secondary memory; and,
playing at least a portion of the retrieved musical media file to the user during the user's performance of least a portion of the preestablished exercise regimen to which the desired pace value corresponds.

26. The method according to claim 25 wherein each of the plurality of musical media files is further associated with one or more weighting values; each of the weighting values being indicative of a selection preference of the user.

27. The method according to claim 26 further including selecting a musical media file from the plurality of musical media files in further dependence upon the one or more weighting values.

28. The method according to claim 25 wherein the approximate footfall rate is dependent at least in part upon a stride length of the user.

29. The method according to claim 28 wherein the stride length is entered by the user.

30. The method according to claim 25 further providing one or more motion sensors, each of the motion sensors being operative to transmit motion signals to the processor indicative of one of; an elapsed time, a current location, a distance traveled, an inclination, a speed, and any combination thereof, accomplished by the user.

31. The method according to claim 30 further including dynamically determining an actual stride length from the one or more received motion signals.

32. The method according to claim 30 further including dynamically determining the actual stride length of the user from the one or more received motion signals in dependence with one of; an actual footfall rate and an actual footfall count.

33. The method according to claim 32 further including determining the actual stride length of the user by dividing the distance traveled by the user by the actual footfall count of the user imparted over the distance traveled.

34. The method according to claim 25 wherein the preestablished exercise regimen is divisible into a plurality of discrete intervals, each of the plurality of discrete intervals having a desired pace value associated therewith.

35. The method according to claim 34 further including selecting another discrete interval based upon the user's completion of a current discrete interval.

36. The method according to claim 25 further including selecting another musical media file for play to the user in dependence on one of; a completion of play of a current musical media file, a completion of a current discrete interval of the preestablished exercise regimen, and any combination thereof.

37. The method according to claim 25 further including applying a tempo adjustment factor to the retrieved musical media file during play; the tempo adjustment factor varying a tempo of the retrieved musical media file during play such that the musical beat rate more closely corresponds to the approximate footfall rate.

38. The method according to claim 31 further including determining if the actual stride length of the user has varied during the playing of the musical media file; and compensating for the variations in the actual stride length by varying a tempo of the playing musical media file such that the musical beat rate provides an opportunity for the user to achieve compliance with the desired pace value.

39. A computer program product embodied in a tangible form comprising instructions executable by a processor associated with a portable media player to intelligently select and play musical media files by;
retrieving a preestablished exercise regimen from a secondary memory functionally coupled to the processor;
determining an approximate footfall rate for a user in dependence on at least a desired pace value included in the retrieved preestablished exercise regimen;
selecting a musical media file from a plurality of musical media files in the secondary memory based at least in part upon the selected musical media file having a musical beat rate which more closely corresponds to the approximate footfall rate than other of the plurality of musical media files;
retrieving the selected musical media file from the secondary memory; and,
playing at least a portion of the retrieved musical media file to the user during the user's performance of at least a portion of the preestablished exercise regimen to which the desired pace value corresponds.

40. The computer program product according to claim 39 wherein the preestablished exercise regimen is divisible into a plurality of discrete intervals, each of the discrete intervals having a desired pace value associated therewith.

41. The computer program product according to claim 39 wherein each discrete interval is one of, a time interval, a distance interval, a number of footfalls, and any combination thereof.

42. The computer program product according to claim 39 wherein the desired pace value is one of, a footfall rate, a time to achieve a specific distance, a speed and any combination thereof.

43. The computer program product according to claim 40 wherein each of the plurality of musical media files is further associated with one or more weighting values; each of the one or more weighting values being indicative of a selection preference of the user.

44. The computer program product according to claim 43 wherein the instructions executable by the processor further includes; selecting the musical media file in further dependence upon the one or more weighting values.

45. The computer program product according to claim 39 wherein the approximate footfall rate of the user is dependent at least in part upon an approximate stride length of the user.

46. The computer program product according to claim 45 further including instructions executable by the processor to dynamically determine an actual stride length of the user from one or more received sensor signals; the received sensor signals being indicative of one of, an actual distance traveled, a speed, an actual footfall rate, an actual footfall count and any combination thereof, accomplished by the user.

47. The computer program product according to claim 39 wherein the tangible form is one of; a logical media, a magnetic media and an optical media.
